(19) United States
(12) Patent Application Publication
(10) Pub. No.: US 2009/0249209 A1
(43) Pub. Date: Oct. 1, 2009

(54) CONTENT REPRODUCING APPARATUS AND CONTENT REPRODUCING METHOD

(75) Inventors: Seiichi Hisada, Iwaki-city (JP); Shintaro Kurasawa, Iwaki-city (JP)

Correspondence Address: ALPINE/BHGL, P.O. Box 10395, Chicago, IL, 60610, US

(73) Assignee: ALPINE ELECTRONICS, INC., Shinagawa-ku (JP)

(21) Appl. No.: 12/410,142

(22) Filed: Mar. 24, 2009

(30) Foreign Application Priority Data
Apr. 1, 2008 (JP) 2008-094579

(51) Int. Cl. G06F 3/048

(52) U.S. Cl. 715/727

(57) ABSTRACT

A content reproducing apparatus and a content reproducing method reproduce sound from image data or music data from the beginning, in a case where music data and image data is obtained from a content storage device and reproduced in succession. An input receiving unit receives a user's input, an external-output requesting unit requests a content storage device to externally output contents, and a reproducing unit reproduces the contents. The external-output requesting unit requests the content storage device to externally output the corresponding music data and the corresponding image data in analog format based on the input received by the input receiving unit, in order to cause the reproduction unit to reproduce music data and image data in succession. As a result, the content reproducing apparatus and method eliminate the necessity of switching reproduction of digital (or analog) information to the reproduction of analog (or digital) information, for reproducing the image (or music) data immediately after the music (or image) data.

### BACKGROUND

1. Related Applications

The present application claims priority to Japanese Patent Application Number 2008-094579, filed Apr. 1, 2008, the entirety of which is hereby incorporated by reference.

2. Field of the Invention

The present invention relates to a content reproducing apparatus and a content reproducing method, and specifically to a content reproducing apparatus and a content reproducing method for obtaining and reproducing contents from a content storage device in which contents are stored.

3. Description of the Related Art

Portable content storage devices for reproducing contents stored therein such as music data and image data are known. Some of such portable content storage devices output the contents to a separate content reproducing apparatus suitable for simultaneous listening and viewing by a plurality of persons (for example, iPod (registered trademark)).

Conventionally, no matter which of music data or image data content is input from a portable content storage device, the content reproducing apparatus receives analog information from a portable content storage device after digital-analog (DA) conversion. Recently, however, when the content input from a portable content storage device is music data, digital information is input from the portable content storage device. In short, the content reproducing apparatus obtains music data in the form of digital information and image data in the form of analog information from the portable content storage device.

Although it is not for external output but for reproduction, there are known reproducing apparatuses that automatically switch the reproduction mode when the information recorded in a recording medium switches from analog information to digital information or from digital information to analog information during reproduction (see, for example, Japanese Patent Application Publication No. 1998 (H10)-255392).

However, when image data is reproduced immediately after music data, the content reproducing apparatus starts reproducing image data and determines that the type of the content reproduced immediately before (digital information (music data)) is different from the type of the content being reproduced now (analog information (image data)) based on the status read while reproducing the image data. When it is determined that the types of the contents are different from each other, the content reproducing apparatus switches the process from reproduction of digital information to reproduction of analog information. After completion of switching, the content reproducing apparatus starts outputting the sound of image data from the midstream (a part to be output after completion of switching). Therefore, in the case of reproducing image data immediately after music data, there is a problem that sound at the beginning of the image data (a part to be output between the start of the reproduction and the completion of the switching operation) is not output.

In the same manner, when music data is reproduced immediately after image data, the content reproducing apparatus starts reproducing music data and determines that the type of the content reproduced immediately before (analog information (image data)) is different from the type of the content being reproduced now (digital information (music data)) based on the status read while reproducing the music data. When it is determined that the types of the contents are different from each other, the content reproducing apparatus switches the process from reproduction of the analog information to reproduction of the digital information. After completion of switching, the content reproducing apparatus starts outputting the sound of music data from the midstream. Therefore, in the case of reproducing music data immediately after image data, there is a problem that the sound at the beginning of the music data is not output.

### SUMMARY

The present invention has been made to provide a solution to the above problems. Namely, the present invention makes it possible to output the sound of image data or music data to be reproduced in succession from the beginning, both when the content reproducing apparatus reproduces image data immediately after music data and when it reproduces music data immediately after image data.

To solve the problems described above, a content reproducing apparatus according to one embodiment of the present invention includes an input receiving unit for receiving a user's input, an external-output requesting unit for requesting a content storage device to output the content, and a reproducing unit for reproducing music data and image data. The external-output requesting unit is configured to request the content storage device to externally output music data and image data in an analog format based on the user's input received by the input receiving unit, when the reproducing unit reproduces music data and image data in succession.

According to an aspect of the embodiment configured as described above, when the content reproducing apparatus reproduces image data immediately after music data, there is no need for switching a process from reproduction of digital information to reproduction of analog information. This is because the content reproducing apparatus needs only to reproduce both music data and image data in the form of analog information, as the content reproducing apparatus obtains not only music data but also image data in the form of analog information when the content reproducing apparatus reproduces image data immediately after music data. In the same manner, when the content reproducing apparatus reproduces music data immediately after image data, there is no need of switching the process from reproduction of analog information to reproduction of digital information. This is because the content reproducing apparatus needs only to reproduce both image data and music data in the form of analog information, as the content reproducing apparatus obtains not only image data but also music data in the form of analog information when the content reproducing apparatus reproduces music data immediately after image data. Therefore, both when the content reproducing apparatus reproduces image data immediately after music data and when the content reproducing apparatus reproduces music data immediately after image data, the sound of image data or music data to be subsequently reproduced can be output from the beginning.

### BRIEF DESCRIPTION OF THE DRAWINGS

FIG. 1 is a diagrammatic view of a content reproducing apparatus according to an embodiment of the present invention and a content storage device connected to the content reproducing apparatus;

FIG. 2 is an exemplary block diagram of the content reproducing apparatus and the content storage device shown in FIG. 1;

FIG. 3 is a schematic diagram of an example of a display on a monitor of the content reproducing apparatus shown in FIG. 1; and

FIG. 4 is a flowchart of an exemplary operation of the content reproducing apparatus and the content storage device shown in FIG. 1.

### DETAILED DESCRIPTION OF THE PREFERRED EMBODIMENTS

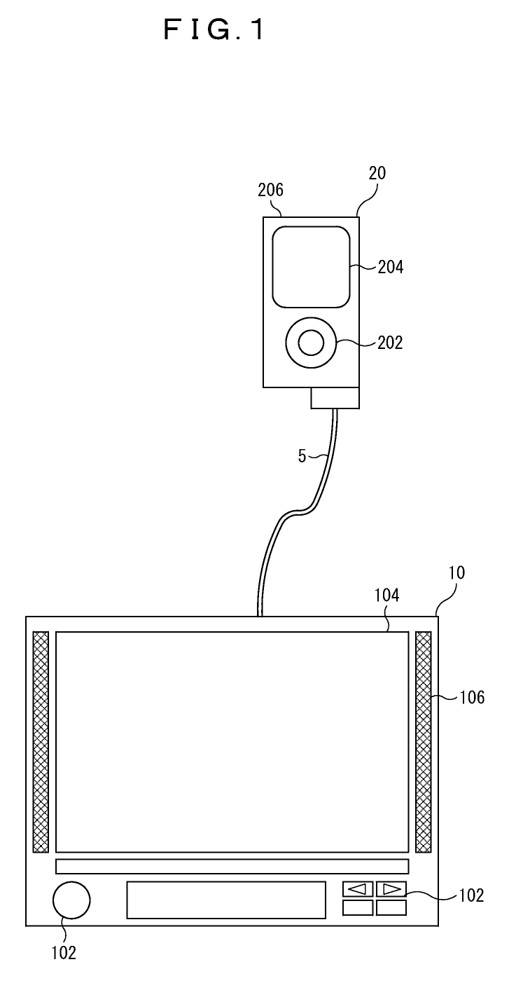

An embodiment of the present invention is described below with reference to the accompanying drawings. FIG. 1 is a diagrammatic view of a content reproducing apparatus 10 according to an embodiment of the present invention and a content storage device 20 connected to the content reproducing apparatus 10. The content storage device 20 shown in FIG. 1 stores therein music data and image data, which are in digital format, and reproduces music data and image data stored therein.

The content storage device 20 includes a button 202 for receiving an input operation by a user, a monitor 204 that displays information related to music data and image data to the user, and a headphone terminal 206 that outputs the sound of music data and image data. The content storage device 20 is connected to the content reproducing apparatus 10 via a cable 5. The content storage device 20 outputs music data and image data stored therein to the content reproducing apparatus 10 via the cable 5. The cable 5 is, for example, compliant with a specification such as Universal Serial Bus (USB) and IEEE 1394. Alternatively, the content storage device 20 can be connected to the content reproducing apparatus 10 wirelessly instead of using the cable 5.

The content reproducing apparatus 10 obtains music data and image data output from the content storage device 20 via the cable 5 and reproduces the music data and image data obtained from the content storage device 20. The content reproducing apparatus 10 includes a button 102 that receives an input operation by the user, a monitor 104 that displays information related to music data and image data to the user, and a speaker 106 that outputs the sound of music data and image data.

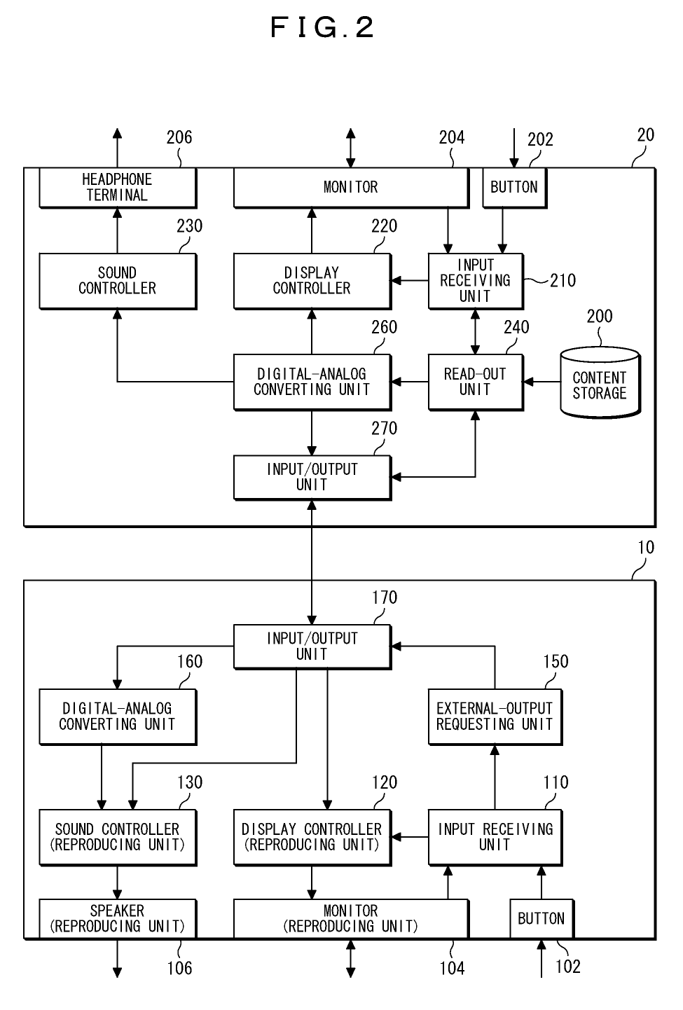

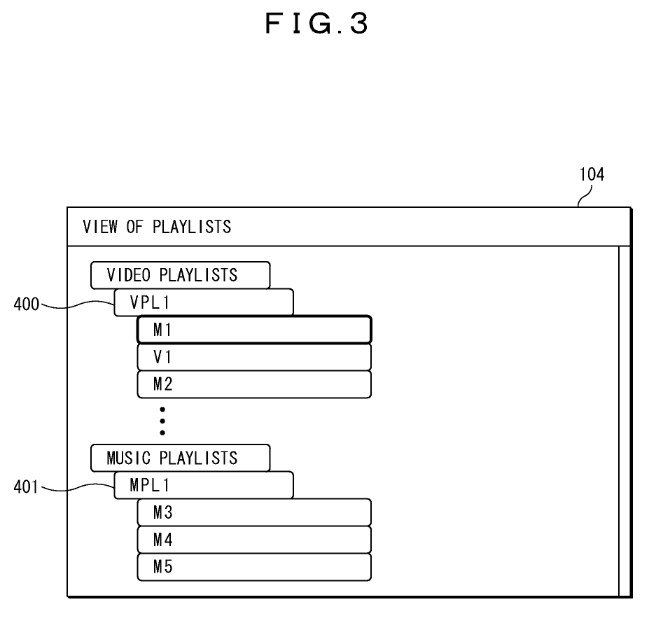

FIG. 2 is an exemplary block diagram of the content reproducing apparatus 10 and the content storage device 20 shown in FIG. 1. FIG. 3 is a schematic diagram of an example of a display on the monitor 104 of the content reproducing apparatus 10 shown in FIG. 1. As shown in FIG. 2, the content reproducing apparatus 10 includes an input receiving unit 110, a display controller 120, a sound controller 130, an external-output requesting unit 150, a digital-analog converting unit 160, and an input/output unit 170, in addition to the button 102, the monitor 104, and the speaker 106 shown in FIG. 1. The monitor 104, the speaker 106, the display controller 120, and the sound controller 130 correspond to a reproducing unit of the present invention.

The content storage device 20 includes a content storage 200, an input receiving unit 210, a display controller 220, a sound controller 230, a read-out unit 240, a digital-analog converting unit 260, and an input/output unit 270, in addition to the button 202, the monitor 204, and the headphone terminal 206 shown in FIG. 1.

The content storage 200 of the content storage device 20 stores therein music data and image data. The content storage 200 further stores therein a video playlist and a music playlist. The video playlist indicates one or more pieces of image data alone, or both one or more pieces of image data and one or more pieces of music data. The music playlist indicates one or more pieces of music data. Other functional blocks of the content storage device 20, such as the input receiving unit 210, will be described later.

The display controller 120 of the content reproducing apparatus 10 obtains a view of playlists stored in the content storage 200 of the content storage device 20 through the input/output unit 170. The display controller 120 displays the view of the playlists obtained through the input/output unit 170 on the monitor 104. For example, the display controller 120 displays information of the playlists on the monitor 104 as shown in FIG. 3.

In the example shown in FIG. 3, “VPL1” indicates a video playlist (title), and “MPL1” indicates a music playlist (title). The video playlist “VPL1” includes a piece of music data “M1”, a piece of image data “V1”, and a piece of music data “M2” (to be reproduced in the order of music data “M1”, image data “V1”, and music data “M2”). The music playlist “MPL1” includes a piece of music data “M3”, a piece of music data “M4”, and a piece of music data “M5” (to be reproduced in the order of music data “M3”, music data “M4”, and music data “M5”).

Furthermore, the display controller 120 obtains an image portion of analog-converted image data from the input/output unit 170. The display controller 120 outputs the image portion of the analog-converted image data obtained from the input/output unit 170 to the monitor 104.

The sound controller 130 of the content reproducing apparatus 10 obtains analog-converted music data from one of the digital-analog converting unit 160 and the input/output unit 170. The sound controller 130 outputs the analog-converted music data obtained from one of the digital-analog converting unit 160 and the input/output unit 170 to the speaker 106. The sound controller 130 also obtains a sound portion of the analog-converted image data from the input/output unit 170. The sound controller 130 outputs the sound portion of the analog-converted image data obtained from the input/output unit 170 to the speaker 106.

The input receiving unit 110 receives the user's input through the button 102 and a virtual button output on the monitor 104 (an object displayed on the monitor 104, which functions as an input interface). More specifically, the input receiving unit 110 receives an input of an instruction to display the view of the playlists. In this case, the input receiving unit 110 sends a request that the playlists should be displayed (hereinafter, “playlist-view display request”) to the external-output requesting unit 150.

Furthermore, the input receiving unit 110 receives an input of an instruction to reproduce only music data via a virtual button to select a music playlist. In this case, the input receiving unit 110 sends an instruction that music data included in the corresponding music playlist should be reproduced in succession (hereinafter, “music-data reproduction request”) to the external-output requesting unit 150. For example, when the input receiving unit 110 receives an input of the instruction that music data “M3” should be reproduced via a virtual button 401 to select the music playlist “MPL1” shown in FIG. 3, the input receiving unit 110 sends the music-data reproduction request that music data “M4” and “M5” should be reproduced immediately after music data “M3” to the external-output requesting unit 150.

Moreover, the input receiving unit 110 receives an input of an instruction to reproduce only image data via a virtual button to select a video playlist including only image data. In this case, the input receiving unit 110 sends an instruction that image data included in the corresponding video playlist should be reproduced in succession (hereinafter, “image-data reproduction request”) to the external-output requesting unit 150.

Furthermore, the input receiving unit 110 receives an input of an instruction to reproduce both music data and image data via a virtual button to select a video playlist including both music data and image data. In this case, the input receiving unit 110 sends an instruction that music data and image data included in the corresponding video playlist should be reproduced in succession (hereinafter, “music/image-data reproduction request”) to the external-output requesting unit 150.

For example, when the input receiving unit 110 receives an input of the instruction that music data “M1” should be reproduced via a virtual button 400 to select the video playlist “VPL1” shown in FIG. 3, the input receiving unit 110 sends the music/image-data reproduction request that image data “V1” and music data “M2” should be reproduced immediately after music data “M1” to the external-output requesting unit 150.

The external-output requesting unit 150 obtains the playlist-view display request from the input receiving unit 110. In this case, the external-output requesting unit 150 sends a request that the view of the playlists should be externally output (hereinafter, “playlist-view external-output request”) to the input/output unit 170.

Furthermore, the external-output requesting unit 150 obtains the music-data reproduction request from the input receiving unit 110. In this case, the external-output requesting unit 150 sends a request that music data indicated by the corresponding music-data reproduction request should be externally output in digital format (hereinafter, “music-data digital external-output request”) to the input/output unit 170.

Moreover, the external-output requesting unit 150 obtains the image-data reproduction request from the input receiving unit 110. In this case, the external-output requesting unit 150 sends a request that image data indicated by the corresponding image-data reproduction request should be externally output in analog format (hereinafter, “image-data analog external-output request”) to the input/output unit 170.

Furthermore, the external-output requesting unit 150 obtains the music/image-data reproduction request from the input receiving unit 110. In this case, the external-output requesting unit 150 sends a request that music data and image data indicated by the corresponding music/image-data reproduction request should be externally output in analog format (hereinafter, “music/image-data analog external-output request”) to the input/output unit 170.

The input/output unit 170 of the content reproducing apparatus 10 obtains the playlist-view external-output request from the external-output requesting unit 150. In this case, the input/output unit 170 sends the playlist-view external-output request to the input/output unit 270 of the content storage device 20. The same process is performed when the input/output unit 170 obtains the music-data digital external-output request, the image-data analog external-output request, and the music/image-data analog external-output request.

Furthermore, the input/output unit 170 obtains the view of the playlists stored in the content storage 200 of the content storage device 20 from the input/output unit 270 of the content storage device 20 to which the playlist-view external-output request is sent. In this case, the input/output unit 170 supplies the display controller 120 with the view of the playlists.

Moreover, the input/output unit 170 obtains one or more pieces of music data before analog conversion included in the specified music playlist from the input/output unit 270 of the content storage device 20 to which the music-data digital external-output request is sent. In this case, the input/output unit 170 temporarily stores therein the obtained music data before analog conversion. The input/output unit 170 supplies the digital-analog converting unit 160 with the temporarily stored music data before analog conversion piece by piece.

Furthermore, the input/output unit 170 obtains one or more pieces of analog-converted image data included in the specified video playlist from the input/output unit 270 of the content storage device 20 to which the image-data analog external-output request is sent. In this case, the input/output unit 170 temporarily stores therein the obtained analog-converted image data. The input/output unit 170 supplies the display controller 120 with the image portion and the sound controller 130 with the sound portion of the temporarily stored analog-converted image data piece by piece.

Moreover, the input/output unit 170 obtains one or more pieces of analog-converted music data and one or more pieces of analog-converted image data included in the specified video playlist from the input/output unit 270 of the content storage device 20 to which the music/image-data analog external-output request is sent. In this case, the input/output unit 170 temporarily stores therein the obtained analog-converted music data and the obtained analog-converted image data. The input/output unit 170 supplies the sound controller 130 with the analog-converted music data of the temporarily stored analog-converted music data piece by piece, and supplies the display controller 120 with the image portion and the sound controller 130 with the sound portion of the temporarily stored analog-converted image data piece by piece.

The digital-analog converting unit 160 obtains music data before analog conversion from the input/output unit 170. In this case, the digital-analog converting unit 160 converts the corresponding music data from digital format to analog format, and supplies the sound controller 130 with the analog-converted music data.

The input receiving unit 210 of the content storage device 20 receives an input from the user through the button 202 and a virtual button output to the monitor 204. More specifically, like the input receiving unit 110 of the content reproducing apparatus 10, the input receiving unit 210 receives an input of an instruction to display the view of the playlists, to reproduce only music data, to reproduce only image data, and to reproduce both music data and image data.

When the input receiving unit 210 receives the input to display the view of the playlists, the input receiving unit 210 sends the playlist-view display request to the read-out unit 240. The input receiving unit 210 then obtains the view of the playlists from the read-out unit 240 to which the playlist-view display request is sent, and supplies the display controller 220 with the view of the playlists. Furthermore, when the input receiving unit 210 receives the input to reproduce only music data, the input receiving unit 210 sends the music-data reproduction request to the read-out unit 240. Moreover, when the input receiving unit 210 receives the input to reproduce only image data, the input receiving unit 210 sends the image-data reproduction request to the read-out unit 240. Furthermore, when the input receiving unit 210 receives the input to reproduce both of music data and image data, the input receiving unit 210 sends the music/image-data reproduction request to the read-out unit 240.

The input/output unit 270 of the content storage device 20 obtains the playlist-view external-output request from the input/output unit 170 of the content reproducing apparatus 10. In this case, the input/output unit 270 sends the corresponding playlist-view external-output request to the read-out unit 240. The same process is performed when the input/output unit 270 obtains the music-data digital external-output request, the image-data analog external-output request, and the music/image-data analog external-output request.

Furthermore, the input/output unit 270 obtains the view of the playlists stored in the content storage 200 from the read-out unit 240 to which the playlist-view external-output request is sent. In this case, the input/output unit 270 supplies the input/output unit 170 of the content reproducing apparatus 10 with the view of the playlists.

Moreover, the input/output unit 270 obtains music data before analog conversion stored in the content storage 200 from the read-out unit 240 to which the music-data digital external-output request is sent. In this case, the input/output unit 270 supplies the input/output unit 170 of the content reproducing apparatus 10 with music data before analog conversion (performs a digital external output).

Furthermore, after sending the image-data analog external-output request to the read-out unit 240, the input/output unit 270 obtains the analog-converted image data from the digital-analog converting unit 260. In this case, the input/output unit 270 supplies the input/output unit 170 of the content reproducing apparatus 10 with the analog-converted image data (performs an analog external output).

Moreover, after sending the music/image-data analog external-output request to the read-out unit 240, the input/output unit 270 obtains the analog-converted music data and the analog-converted image data from the digital-analog converting unit 260. In this case, the input/output unit 270 supplies the input/output unit 170 of the content reproducing apparatus 10 with the analog-converted music data and the analog-converted image data (performs the analog external output).

The read-out unit 240 obtains the playlist-view external-output request from the input/output unit 270. In this case, the read-out unit 240 refers to the playlists stored in the content storage 200, generates the view of the playlists, and supplies the input/output unit 270 with the view of the playlists.

Furthermore, the read-out unit 240 obtains the music-data digital external-output request from the input/output unit 270. In this case, the read-out unit 240 reads out music data stored in the content storage 200, and supplies the input/output unit 270 with the music data.

Moreover, the read-out unit 240 obtains the image-data analog external-output request from the input/output unit 270. In this case, the read-out unit 240 reads out image data stored in the content storage 200, and supplies the digital-analog converting unit 260 with the read-out image data along with information for identifying the content reproducing apparatus 10 specified for use as a reproducing apparatus.

Furthermore, the read-out unit 240 obtains the music/image-data analog external-output request from the input/output unit 270. In this case, the read-out unit 240 reads music data and image data stored in the content storage 200, and supplies the digital-analog converting unit 260 with the read-out music data and the read-out image data along with the information for identifying the content reproducing apparatus 10 specified for use as the reproducing apparatus.

Moreover, the read-out unit 240 obtains the playlist-view display request from the input receiving unit 210. In this case, the read-out unit 240 refers to the playlists stored in the content storage 200 to generate the view of the playlists, and supplies the input receiving unit 210 with the view of the playlists.

Furthermore, the read-out unit 240 obtains the music-data reproduction request, the image-data reproduction request, and the music/image-data reproduction request from the input receiving unit 210. When the read-out unit 240 obtains the music-data reproduction request, the read-out unit 240 reads music data stored in the content storage 200, and supplies the digital-analog converting unit 260 with music data along with the information for identifying the corresponding device (content storage device 20) specified for use as the reproducing apparatus. The same process is performed when the read-out unit 240 obtains the image-data reproduction request and the music/image-data reproduction request.

The digital-analog converting unit 260 obtains music data before analog conversion from the read-out unit 240 along with the information for identifying the content reproducing apparatus 10. In this case, the digital-analog converting unit 260 converts the obtained music data from digital format to analog format, and supplies the input/output unit 270 with the analog-converted music data.

Furthermore, the digital-analog converting unit 260 obtains image data before analog conversion from the read-out unit 240 along with the information for identifying the content reproducing apparatus 10. In this case, the digital-analog converting unit 260 converts the obtained image data from digital format to analog format, and supplies the input/output unit 270 with the analog-converted image data.

Moreover, the digital-analog converting unit 260 obtains music data and image data before analog conversion from the read-out unit 240 along with the information for identifying the content reproducing apparatus 10. In this case, the digital-analog converting unit 260 converts the obtained music data and the obtained image data from digital format to analog format, and supplies the input/output unit 270 with the analog-converted music data and the analog-converted image data.

Furthermore, the digital-analog converting unit 260 obtains music data before analog conversion from the read-out unit 240 along with the information for identifying the content storage device 20. In this case, the digital-analog converting unit 260 converts the obtained music data from digital format to analog format, and supplies the sound controller 230 with the analog-converted music data.

Moreover, the digital-analog converting unit 260 obtains image data before analog conversion from the read-out unit 240 along with the information for identifying the content storage device 20. In this case, the digital-analog converting unit 260 converts the obtained image data from digital format to analog format, and supplies the display controller 220 with the analog-converted image data.

Furthermore, the digital-analog converting unit 260 obtains music data and image data before analog conversion from the read-out unit 240 along with the information for identifying the content storage device 20. In this case, the digital-analog converting unit 260 converts the obtained music data and the obtained image data from digital format to analog format, supplies the sound controller 230 with the analog-converted music data, supplies the display controller 220 with the image portion of the analog-converted image data, and supplies the sound controller 230 with the sound portion of the analog-converted image data.

The display controller 220 of the content storage device 20 obtains the view of the playlists stored in the content storage 200 from the input receiving unit 210, and displays the view of the playlists on the monitor 204. Furthermore, the display controller 220 obtains the image portion of the analog-converted image data from the digital-analog converting unit 260, and outputs the image portion to the monitor 204.

The sound controller 230 of the content storage device 20 obtains the analog-converted music data from the digital-analog converting unit 260, and outputs music data to the headphone terminal 206. Furthermore, the sound controller 230 obtains the sound portion of the analog-converted image data from the digital-analog converting unit 260, and outputs the sound portion to the headphone terminal 206. The sound controller 230 can output them to the headphone terminal 206 only when a headphone is connected.

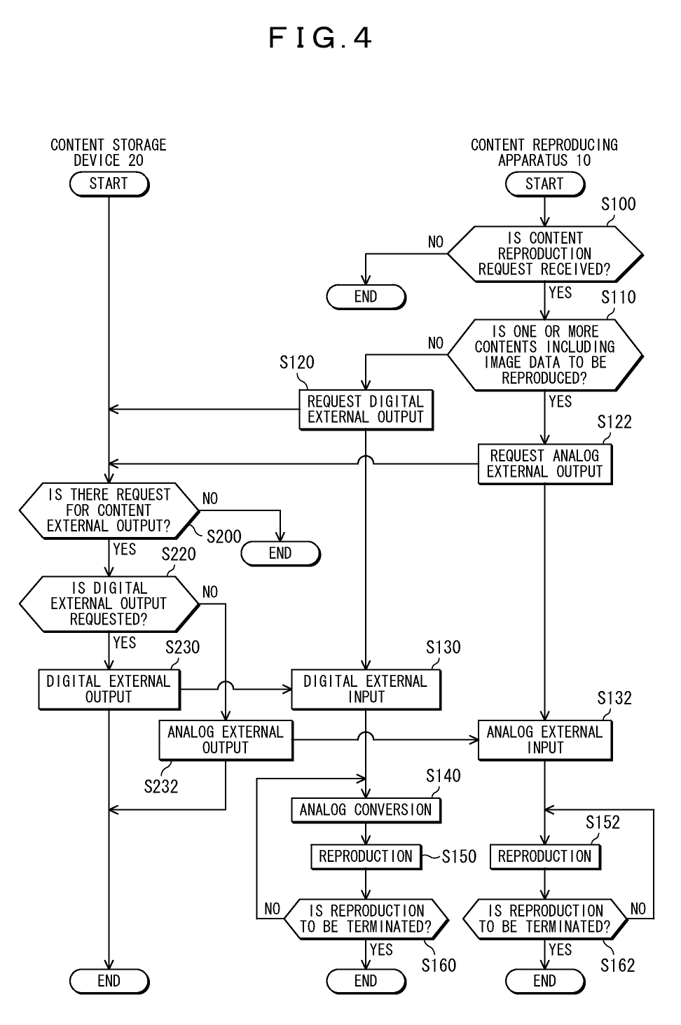

An operation of the content reproducing apparatus 10 and the content storage device 20 is explained below. FIG. 4 is a flowchart of an exemplary operation of the content reproducing apparatus 10 and the content storage device 20 shown in FIG. 1. The operation of the content reproducing apparatus 10 is shown on the right side of the flowchart, and the operation of the content storage device 20 is shown on the left side of the flowchart.

As shown in FIG. 4, the input receiving unit 110 of the content reproducing apparatus 10 determines whether the input of the instruction to reproduce the content is received or not (Step S100). The input receiving unit 110 determines that the input of the instruction to reproduce the content is received when the input receiving unit 110 receives the input of the instruction to reproduce only music data, the input of the instruction to reproduce only image data, or the input of the instruction to reproduce both music data and image data. When the input receiving unit 110 determines that the input of the instruction to reproduce the content is not received (Step S100: NO), the process is terminated.

On the other hand, when the input receiving unit 110 determines that the input of the instruction to reproduce the content is received (Step S100: Yes), the input receiving unit 110 determines whether the input of the instruction to reproduce one or more contents including image data is received or not (Step S110). When the input of the instruction to reproduce only image data or the input of the instruction to reproduce both music data and image data is received, the input receiving unit 110 determines that the input of the instruction to reproduce one or more contents including image data is received.

When the input receiving unit 110 determines that the input of the instruction to reproduce one or more contents including image data is not received (Step S110: No), namely, when the input receiving unit 110 determines that the input of the instruction to reproduce only music data is received, the input receiving unit 110 sends the music-data reproduction request to the external-output requesting unit 150. Upon receipt of the music-data reproduction request from the input receiving unit 110, the external-output requesting unit 150 sends the music-data digital external-output request to the input/output unit 170. Upon receipt of the request, the input/output unit 170 sends the corresponding music-data digital external-output request to the input/output unit 270 of the content storage device 20 (Step S120).

On the other hand, when the input receiving unit 110 determines that the input of the instruction to reproduce one or more contents including image data is received (Step S110: Yes), the input receiving unit 110 sends one of the image-data reproduction request and the music-data reproduction request to the external-output requesting unit 150. More specifically, when the input receiving unit 110 determines that the input of the instruction to reproduce only image data is received, the input receiving unit 110 sends the image-data reproduction request to the external-output requesting unit 150. When the input receiving unit 110 determines that the input of the instruction to reproduce both music data and image data is received, the input receiving unit 110 sends the music/image-data reproduction request to the external-output requesting unit 150.

Upon receipt of the image-data reproduction request from the input receiving unit 110, the external-output requesting unit 150 sends the image-data analog external-output request to the input/output unit 170. Upon receipt of the request, the input/output unit 170 sends the corresponding image-data analog external-output request to the input/output unit 270 of the content storage device 20 (Step S122). In the same manner, upon receipt of the music/image-data reproduction request from the input receiving unit 110, the external-output requesting unit 150 sends the music/image-data analog external-output request to the input/output unit 170. Upon receipt of the request, the input/output unit 170 sends the corresponding music/image-data analog external-output request to the input/output unit 270 of the content storage device 20 (Step S122).

The input/output unit 270 of the content storage device 20 determines whether the external output request of the content is received from the input/output unit 170 of the content reproducing apparatus 10 or not (Step S200). When one of the music-data digital external-output request, the image-data analog external-output request, and the music/image-data analog external-output request is received, the input/output unit 270 determines that the external output request of the content is received. When the input/output unit 270 determines that the external output request of the content is not received from the input/output unit 170 of the content reproducing apparatus 10 (Step S200: No), the process is terminated.

On the other hand, when the input/output unit 270 determines that the external output request of the content is received (Step S200: Yes), the input/output unit 270 determines whether the digital external-output request of the content is received or not (Step S220). When the music-data digital external-output request is received, the input/output unit 270 determines that the digital external-output request of the content is received.

When the input/output unit 270 determines that the digital external-output request of the content is received (Step S220: Yes), the input/output unit 270 sends the corresponding digital external-output request to the read-out unit 240. Upon receipt of the digital external-output request from the input/output unit 270, the read-out unit 240 reads music data stored in the content storage 200, and supplies the input/output unit 270 with music data. The input/output unit 270 then outputs music data obtained from the read-out unit 240 before analog conversion to the input/output unit 170 of the content reproducing apparatus 10 in digital format (Step S230).

On the other hand, when the input/output unit 270 determines that the digital external-output request of the content is not received (Step S220: No), namely, when the input/output unit 270 determines that one of the image-data analog external-output request and the music/image-data analog external-output request is received, the input/output unit 270 sends the corresponding one of the image-data analog external-output request and the music/image-data analog external-output request to the read-out unit 240.

Upon receipt of the image-data analog external-output request from the input/output unit 270, the read-out unit 240 reads out image data stored in the content storage 200, and supplies the digital-analog converting unit 260 with image data along with the information for identifying the content reproducing apparatus 10 specified for use as the reproducing apparatus. In this case, the digital-analog converting unit 260 converts the corresponding image data from digital format to analog format, and supplies the input/output unit 270 with the analog-converted image data. The input/output unit 270 then externally outputs the analog-converted image data obtained from the digital-analog converting unit 260 to the input/output unit 170 of the content reproducing apparatus 10 in analog format (Step S232).

In the same manner, upon receipt of the music/image-data analog external-output request from the input/output unit 270, the read-out unit 240 reads music data (music data before analog conversion) and image data (image data before analog conversion) stored in the content storage 200, and supplies the digital-analog converting unit 260 with music data and image data along with the information for identifying the content reproducing apparatus 10 specified for use as the reproducing apparatus. In this case, the digital-analog converting unit 260 converts the corresponding music data and the corresponding image data from digital format to analog format, and supplies the input/output unit 270 with the analog-converted music data and the analog-converted image data. The input/output unit 270 then externally outputs the analog-converted music data and the analog-converted image data obtained from the digital-analog converting unit 260 to the input/output unit 170 of the content reproducing apparatus 10 in analog format (Step S232).

Immediately after Step S230, the input/output unit 170 of the content reproducing apparatus 10 inputs music data before analog conversion from the input/output unit 270 of the content storage device 20 in digital format (Step S130). The input/output unit 170 temporarily stores therein music data obtained from the input/output unit 270 before analog conversion, and supplies the digital-analog converting unit 160 with music data piece by piece. The digital-analog converting unit 160 converts the corresponding music data obtained from the input/output unit 170 from digital format to analog format piece by piece, and supplies the sound controller 130 with the analog-converted music data (Step S140).

The sound controller 130 then outputs the analog-converted music data obtained from the digital-analog converting unit 160 to the speaker 106, and reproduces it (Step S150). The sound controller 130 determines whether to terminate the reproduction of music data or not (Step S160). The sound controller 130 determines to terminate the reproduction of music data when all music data temporarily stored in the input/output unit 170 is output to the speaker 106. When the sound controller 130 determines not to terminate the reproduction of music data (Step S160: No), the process returns to Step S140. When the sound controller 130 determines to terminate the reproduction of music data (Step S160: Yes), the process is terminated.

Immediately after Step S232, the input/output unit 170 of the content reproducing apparatus 10 inputs the analog-converted music data or the analog-converted image data from the input/output unit 270 of the content storage device 20 in analog format (Step S132). The input/output unit 170 temporarily stores therein the analog-converted music data or the analog-converted image data obtained from the input/output unit 270. The input/output unit 170 supplies the music controller 130 with the analog-converted music data of the temporarily stored analog-converted music data piece by piece, and supplies the display controller 120 with the image portion and the sound controller 130 with the sound portion of the temporarily stored analog-converted image data piece by piece.

The sound controller 130 outputs the analog-converted music data or the sound portion of the analog-converted image data obtained from the input/output unit 170 to the speaker 106, and reproduces it (Step S152). The display controller 120 outputs the image portion of the analog-converted image data obtained from the input/output unit 170 to the monitor 104, and reproduces it (Step S152).

The sound controller 130 determines whether or not to terminate the reproduction of music data or image data (Step S162). The sound controller 130 determines to terminate the reproduction of music data and image data when all of the music data or image data temporarily stored in the input/output unit 170 is output. When the sound controller 130 determines not to terminate the reproduction of music data and image data (Step S162: No), the process returns to Step S152. When the sound controller 130 determines to terminate the reproduction of music data and image data (Step S162: Yes), the process is terminated.

As described above, with the content reproducing apparatus 10 according to the embodiment, when the content reproducing apparatus 10 reproduces image data immediately after music data, both music data and image data are externally input from the content storage device 20 in analog format. Therefore, there is no need for switching the reproduction of the digital information to the reproduction of the analog information required when image data externally input in analog format is reproduced immediately after music data externally input in digital format is reproduced. This is because both music data and image data are externally input in analog format, and therefore neither uses the digital-analog converting unit 160.

In the same manner, when the content reproducing apparatus 10 reproduces music data immediately after image data, both image data and music data are externally input from the content storage device 20 in analog format. Therefore, there is no need for switching the reproduction of the analog information to the reproduction of the digital information required when music data externally input in digital format is reproduced immediately after image data externally input in analog format is reproduced with image data to be reproduced immediately after the image data). This is because both image data and music data are externally input in analog format, and therefore neither uses the digital-analog converting unit 160. Therefore, in both of the cases where the content reproducing apparatus reproduces image data immediately after music data and where the content reproducing apparatus reproduces music data immediately after image data, the sound of image data or music data to be reproduced immediately afterward can be output from the beginning.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

1. A content reproducing apparatus for obtaining and reproducing music data externally output in digital format or an analog format and image data externally output in an analog format from a content storage device in which music data and image data are stored as digital content, the content reproducing apparatus comprising:
an input receiving unit for receiving a user's input;
an external-output requesting unit for requesting the content storage device to externally output music data and image data in analog format, in order to cause music data and image data to be reproduced in succession based on the user's input received by the input receiving unit; and
a reproducing unit for reproducing music data and image data externally output from the content storage device in analog format.

2. A content reproducing apparatus according to claim 1, wherein
the content storage device is a portable terminal device, and
the content reproducing apparatus is an on-vehicle content reproducing apparatus.

3. A content reproducing apparatus according to claim 1, wherein
the content storage device stores therein a playlist indicative of a plurality of contents including music data and image data,
the input receiving unit receives an input of an instruction to reproduce music data and image data in succession based on the playlist, and
when the input receiving unit receives an input of the instruction to reproduce music data and image data in succession based on the playlist, the external-output requesting unit requests the content storage device to externally output music data and image data in analog format.

4. A content reproducing apparatus according to claim 3, wherein
the content storage device is a portable terminal device, and
the content reproducing apparatus is an on-vehicle content reproducing apparatus.

5. A content reproducing apparatus according to claim 1, further comprising a digital-analog converting unit for converting music data from digital format to analog format, wherein
in order to reproduce only music data based on the user's input received by the input receiving unit, the external-output requesting unit requests the content storage device to externally output music data in digital format,
the digital-analog converting unit converts music data externally output from the external-output requesting unit in digital format to analog format, and
the reproducing unit reproduces music data converted to analog format by the digital-analog converting unit.

6. A content reproducing apparatus according to claim 5, wherein
the content storage device is a portable terminal device, and
the content reproducing apparatus is an on-vehicle content reproducing apparatus.

7. A content reproducing apparatus according to claim 5, wherein
the content storage device stores therein a playlist indicative of one or more contents including only music data,
the input receiving unit receives the input of an instruction to reproduce only music data based on the playlist, and
upon receipt of the instruction to reproduce only music data based on the playlist, the external-output requesting unit requests the content storage device to externally output music data in digital format.

8. A content reproducing apparatus according to claim 7, wherein
the content storage device is a portable terminal device, and
the content reproducing apparatus is an on-vehicle content reproducing apparatus.

9. A content reproducing method of obtaining and reproducing music data externally output in digital format or an analog format and image data externally output in an analog format from a content storage device in which music data and image data are stored as digital content, the content reproducing method comprising:
an input receiving act of receiving a user's input;
an external-output requesting act of requesting the content storage device to externally output music data and image data in analog format, in order to cause music data and image data to be reproduced in succession based on the user's input received at the input receiving act; and
a reproducing act of reproducing music data and image data externally output from the content storage device in analog format.

10. A content reproducing method according to claim 9, wherein
the content storage device is a portable terminal device, and
the content reproducing apparatus is an on-vehicle content reproducing apparatus.

11. A content reproducing method according to claim 9, wherein, in a case where a playlist indicative of a plurality of contents including music data and image data are stored in the content storage device,
the input receiving act includes receiving an input of an instruction to reproduce music data and image data in succession based on the playlist, and
the external-output requesting act includes, when an input of the instruction to reproduce music data and image data in succession based on the playlist is received at the input receiving act, requesting the content storage device to externally output music data and image data in analog format.

12. A content reproducing method according to claim 11, wherein
the content storage device is a portable terminal device, and
the content reproducing apparatus is an on-vehicle content reproducing apparatus.

13. A content reproducing method according to claim 9, further comprising a digital-analog converting act of converting music data from digital format to analog format, wherein
the external-output requesting act includes, in order to reproduce only music data based on the user's input received at the input receiving act, requesting the content storage device to externally output music data in digital format,
the digital-analog converting act includes converting music data externally output from the external-output requesting unit in digital format to analog format, and
the reproducing act includes reproducing music data converted to analog format at the digital-analog converting act.

14. A content reproducing method according to claim 13, wherein
the content storage device is a portable terminal device, and
the content reproducing apparatus is an on-vehicle content reproducing apparatus.
